(19) United States
(12) Patent Application Publication
(10) Pub. No.: US 2023/0184916 A1
(43) Pub. Date: Jun. 15, 2023

(54) ULTRA-WIDE BAND TEST SYSTEM

(71) Applicant: ASSA ABLOY AB, Stockholm (SE)

(72) Inventor: Hans-Juergen Pirch, Feldkirchen (AT)

(21) Appl. No.: 17/998,376

(22) PCT Filed: May 5, 2021
(86) PCT No.: PCT/EP2021/061875

§ 371 Date: Nov. 10, 2022

Related U.S. Application Data
(60) Provisional application No. 63/023,972, filed on May 13, 2020.

(51) Int. Cl. G01S 13/02; H04B 17/00; H04B 17/391

(52) U.S. Cl. CPC G01S 13/0209; H04B 17/0085; H04B 17/3912

(57) ABSTRACT

A test system comprises a radio frequency (RF) shielded container, the shielded container to house a UWB receiver device under test; an RF antenna arranged within the RF shielded container; and a UWB transmitter device operatively coupled to the RF antenna. The UWB transmitter device is configured to transmit a UWB signal within the RF shielded container using the antenna, wherein the transmitted UWB signal is representative of multi-path components (MPCs) of resulting signals in an end-use environment of the UWB receiver device resulting from transmitting a UWB ranging signal in the end-use environment.

### PRIORITY APPLICATION

This application claims priority to U.S. Provisional Application Ser. No. 63/023,972, filed May 13, 2020, the disclosure of which is incorporated herein in its entirety by reference.

### TECHNICAL FIELD

Embodiments illustrated and described herein generally relate to access control system architectures that include ultra-wide band enabled devices, and in particular to systems and methods for testing ultra-wide band enabled devices.

### BACKGROUND

Ultra-Wide Band (UWB) is a radio frequency (RF) technique that uses short, low power, pulses over a wide frequency spectrum. The pulses are on the order of millions of individual pulses per second. The width of the frequency spectrum is generally greater than 500 megahertz or greater than twenty percent of an arithmetic center frequency.

### BRIEF DESCRIPTION OF THE DRAWINGS

FIG. 1 is an illustration of a basic Physical Access Control System (PACS) structure.

FIG. 2 is a block diagram of an example of an ultra-wide band (UWB) capable device and a Smart UWB capable device including angle of arrival capability.

FIG. 3 is a block diagram illustrating portions of an example of a UWB seamless PACS.

FIGS. 4A and 4B are examples of radio packets that can be sent during a ranging operation.

FIG. 5 is an illustration of an example of deconvolution operation of a ranging procedure by a seamless PACS.

FIG. 6 is a diagram of a test system for a device of a seamless PACS.

FIG. 7 graphically illustrates a simulation approach to determining a UWB test signal.

FIG. 8 shows waveforms associated with developing a UWB test signal using simulation.

FIG. 9 is a flow diagram of a method of operating a seamless PACS.

FIG. 10 is a block diagram schematic of portions of an example of a UWB capable device.

### DETAILED DESCRIPTION

UWB is a radio communication methodology that uses a wide signal bandwidth. The wide bandwidth is typically defined as either a −10 decibel (−10 dB) bandwidth greater than 20% of the center frequency of the signal, or a bandwidth greater than 500 megahertz (500 MHz) in absolute terms. Commercial UWB systems are intended to be used in complex environments such as residential, office, or industrial indoor areas.

As an example, UWB radio communications can be used in a Physical Access Control System (PACS). A PACS authenticates and authorizes a person to pass through a physical access point such as a secured door. The environment of a PACS may vary significantly based on the application (e.g., a hotel, a residence, an office, etc.), the technology (e.g., access interfaces technology, door type, etc.), and the manufacturer.

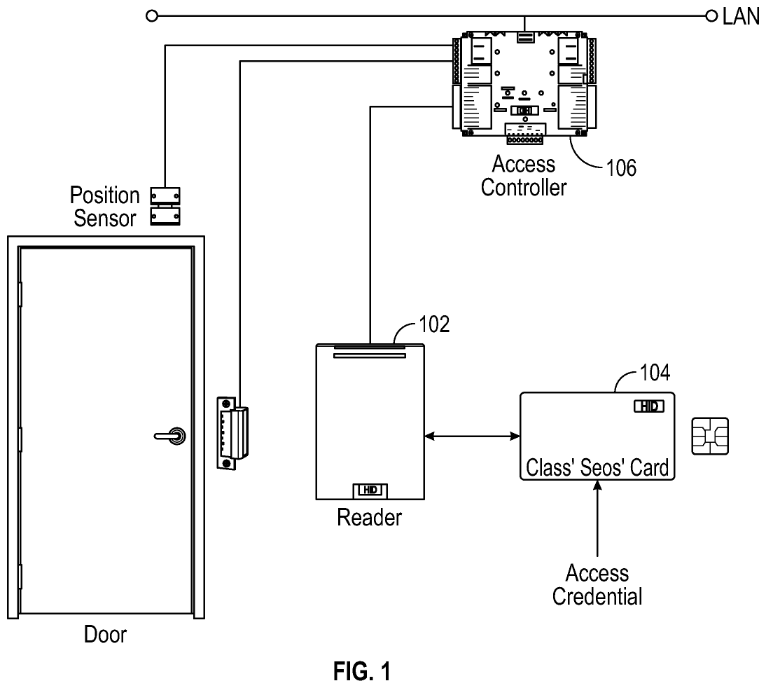

FIG. 1 is an illustration of a basic PACS structure useful for an office application. The Access Credential is a data object, a piece of knowledge (e.g., PIN, password, etc.), or a facet of the person's physical being (e.g., face, fingerprint, etc.) that provides proof of the person's identity. The Credential Device 104 stores the Access Credential when the Access Credential is a data object. The Credential Device 104 may be a smartcard or smartphone. Other examples of Credential Devices include, but are not limited to, proximity radio frequency identification based (RFID-based) cards, access control cards, credit cards, debit cards, passports, identification cards, key fobs, near field communication (NFC) enabled devices, mobile phones, personal digital assistants (PDAs), tags, or any other device configurable to emulate a virtual credential.

The Credential Device 104 can be referred to as the Access Credential. The Reader device 102 retrieves and authenticates the Access Credential when a Credential Device is used and sends the Access Credential to the Access Controller 106. The Access Controller 106 compares the Access Credential to an Access Control list and grants or denies access based on the comparison, such as by controlling an automatic lock on a door for example.

The functionality of an Access Controller 106 may be included in the Reader device 102. These Reader devices can be referred to as offline readers or standalone readers. If the unlocking mechanism is included as well, a device is referred to as smart door lock which is more typically used in residential applications. Devices such as smart door locks are often battery powered, and power consumption and battery lifetime can be key parameters for the devices.

In a PACS, an access sequence consists of four parts: Proof of Presence, Intent Detection, Authentication, and Authorization. The user approaches the door and presents their access credential or credential device. This provides the Proof of Presence and Intent portions of the sequence. The reader device checks the validity of the access credential (the Authentication portion) and sends it to the access controller (e.g., using a local area network or LAN), which grants or denies access (the Authorization portion). Seamless access control refers to when physical access is granted to an authorized user through a controlled portal without requiring intrusive actions of the user such as entering or swiping an access card at a card reader or entering a personal identification number (PIN) or password.

Impulse Radio Ultra-Wideband (IR-UWB, or simply UWB) can provide Proof of Presence information in a secure manner. The large bandwidth of UWB systems provides a high level of resilience to frequency selective fading, which is an effect that can limit the performance of narrow-band technologies. The secure and accurate ranging capability of UWB makes it a suitable technology to enable seamless access because the ranging can be used to determine Presence and Intent without a need for actions by the user.

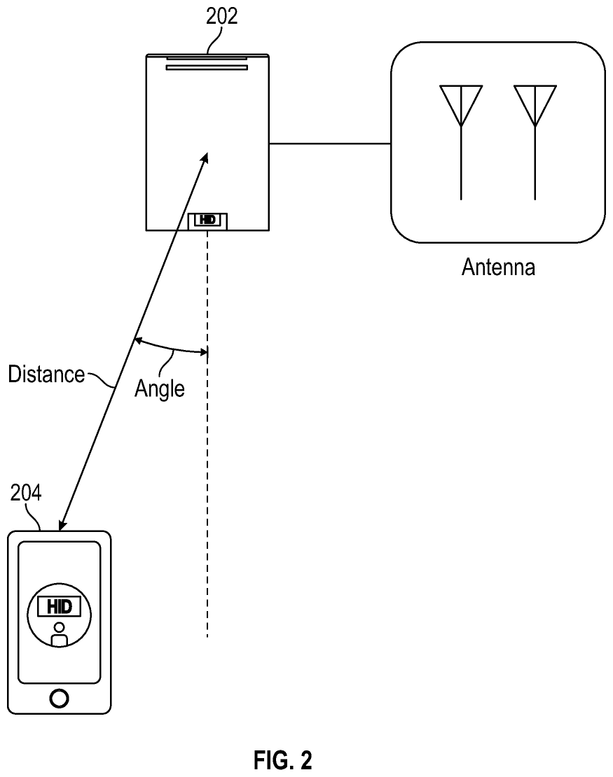

FIG. 2 is a block diagram of an example of a UWB capable device 202 (e.g., a Reader device or Reader & Controller device) and a Smart UWB capable device 204 (e.g., a Smartphone Credential Device). Ranging by the UWB capable devices can be used to determine Intent of the user. Intent can be deduced by the change in distance between the UWB capable device 202 and the Smart UWB capable device 204, and by the change in angle the UWB capable device 202 and the Smart UWB capable device 204.

The UWB capable device may perform ranging using Time-of-Flight (TOF) Two Way Ranging (TWR). In TWR, radio packets are exchanged between the UWB capable device (e.g., the Reader device) and the Smart UWB capable device (e.g., a UWB capable smartphone). The timing differences for the transmitting and receiving of the packets between the Reader device and the smartphone can be used to calculate ranging information such as change in one or both of distance and angle to determine Intent.

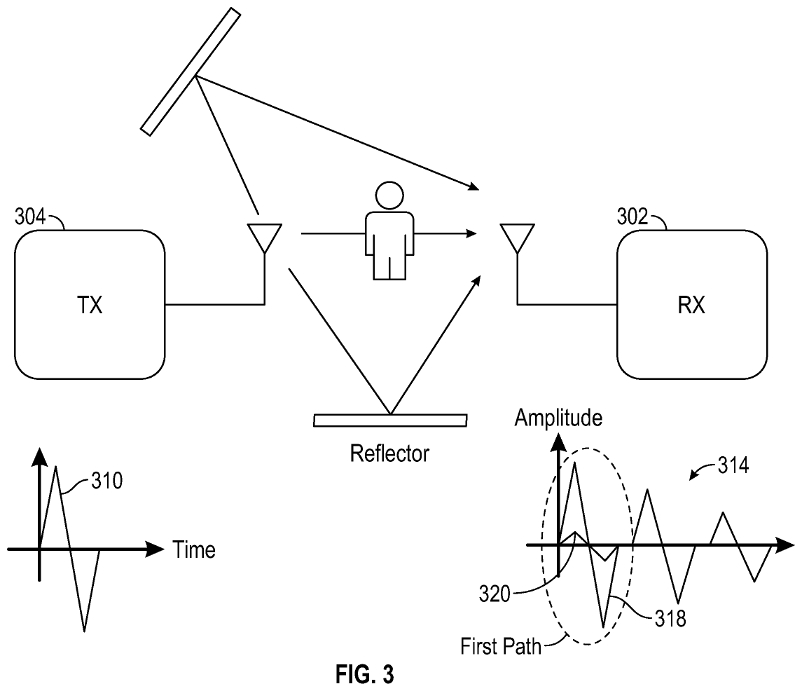

FIG. 3 is a block diagram illustrating portions of an example of a UWB seamless PACS. The transmitter device 304 may be a Smart UWB capable device of a user and the receiver device 302 may be a UWB Reader device. The transmitter device 304 transmits a UWB signal 312 and a receiver device 302 receives a UWB signal 314. The transmitted signal may be sent as part of a ranging operation.

However, as noted previously herein, the environment for a UWB system can be complex. In these environments, signal reflection and diffraction play a significant role. The received UWB signal 314 can be the sum of the attenuated, delayed and possibly overlapping versions of the transmitted signal, and the received UWB signal may vary over time (due to movement of receiver/transmitter or change in environment). These different versions of the transmitted signal that sensed by the receiver device 302 can be referred to as multipath components (MPCs).

For ranging operations by the seamless PACS it is important to identify the first path and determine Time-of-Arrival (TOA) because it is the most representative of the distance between the transmitter device 304 and the receiver device 302. However, the strength of the first path component may depend on the environment. The received UWB signal 314 shows a first path component 318 that has the largest amplitude and a first path component 320 that has a smaller amplitude than other components. The smaller amplitude may occur in the obstructed Line-of-Sight (LOS) scenario in FIG. 3 where there is not a direct a direct path between the transmitter device 304 and the receiver device 302.

To correctly detect LOS TOA the dynamic range of the receiver is improved using correlation. In the correlation operations, the Channel Impulse Response (CIR) is determined or estimated by a correlator of the receiver device 302. The correlator performs deconvolution on a known pulse pattern associated with a radio packet of the incoming UWB signal. The symbols of the known pulse pattern have perfect periodic autocorrelation properties allowing for determination of the CIR via direct correlation.

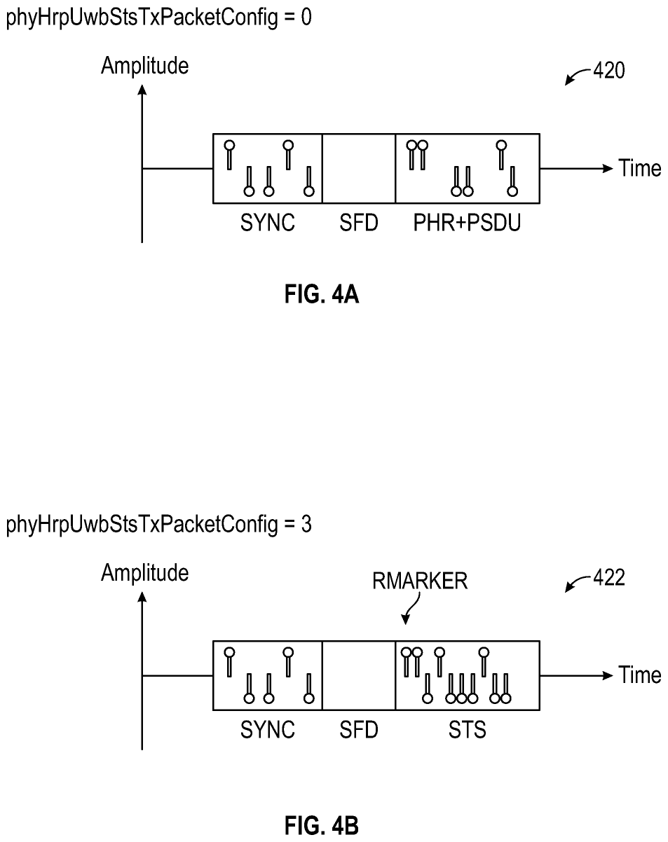

FIGS. 4A and 4B are examples of radio packets that can be sent during a ranging operation. In FIG. 4A, the radio packet 420 includes a synchronization (SYNC) field a start-of-frame delimiter (SFD) field. The SYNC field may include a repeated Ipatov sequence to provide the desired autocorrelation properties, and the SFD field may include a scrambled Ipatov sequence. The radio packet 420 also includes physical layer (PHY) header (PHR) and a PHY service data unit (PSDU).

In FIG. 4B, the radio packet 422 includes the SYNC field and SFD field as in FIG. 4A, but includes a Scrambled Timestamp Sequence (STS) field. Using an STS field provides an additional level of security because the STS filed is not predictable and using an STS field also does not cause periodicity-related peaking in the transmit signal frequency spectrum.

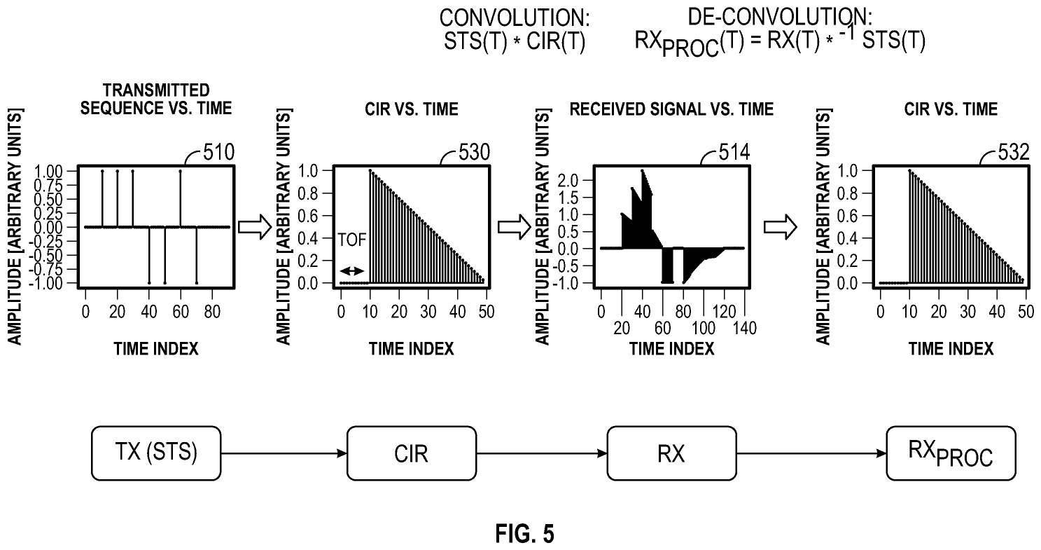

FIG. 5 is an illustration of an example of deconvolution operation of a ranging procedure by a seamless PACS. Waveform 510 represents a transmit signal. The pulses in the waveform represent bits within the radio packets transmitted. Waveform 530 represents the theoretical CIR that would be received by a receiver device. The first path signal has the highest amplitude and the first path is used to determine time-of-flight (TOF) for the ranging procedure.

Waveform 514 represents an actual received signal due to the reflections in the environment of the seamless PACS. Waveform 532 represents the estimated theoretical CIR constructed using deconvolution, and the waveform 532 is used by the receiver device to determine TOF information.

A challenge in implementing a UWB system, such as a PACS, is that because the received signal is a summation of the reflected and direct multi-path components, the received signal summation can be unique for every environment. The circuitry for receiving the signals and the algorithms for deconvolution may have to be optimized for a particular environment. Yet, it would be desirable to have the a UWB system ready to use without time consuming installation procedures to optimize the UWB system.

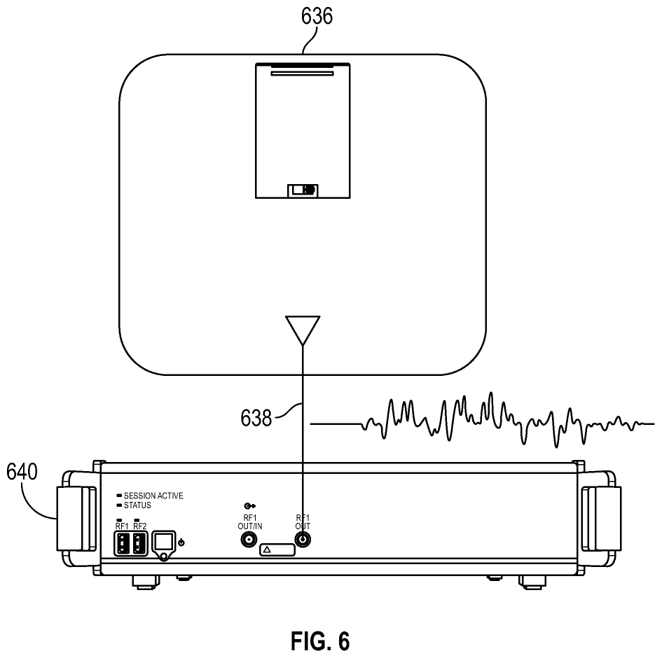

FIG. 6 is a diagram of a test system 600 for a UWB capable device (e.g., of a seamless PACS). The test system 600 includes an RF shielded container 636 (e.g., a box) to house a UWB receiver device 602 under test by the system. The UWB receiver device may be a UWB Reader device or a Smart UWB capable device. The test system 600 also includes an RF antenna 638 arranged within the RF shielded container 636 and a UWB transmitter device 640. The UWB transmitter device 640 is operatively coupled to the RF antenna and configured to transmit a UWB signal within the RF shielded container using the antenna. The UWB transmitter device 640 may include a UWB physical layer (PHY) that transmits signals in the UWB signal band. Other layers may be implemented in processing circuitry of the UWB transmitter device 640. The RF shielded container 636 may be about one-half cubic meter in size and may include RF attenuators to attenuate signals transmitted by the antenna within the container.

As explained previously herein, a UWB ranging signal transmitted in an end-use environment will result in attenuated, delayed, time varying and possibly overlapping versions of the transmitted UWB ranging signal in the environment, and the signal received by a UWB receiver device in the environment will include MPCs because of the diverse paths reflected signals may take in the environment. Using the antenna, the UWB transmitter device 640 transmits a UWB signal within the RF shielded container that is representative of the MPCs that occur resulting from transmitting a UWB ranging signal in the unique end-use environment in which the UWB receiver device will be used.

To determine the representative signal, electromagnetic field simulation software can be used. Using the software, the user may set up a model of the end-use environment, and then simulate transmitting one or more ranging signals in the model environment. The transmitted ranging signal or signals may include one or more of a specified pulse pattern, a radio packet having a specified preamble, or a radio packet that includes a scrambled timestamp sequence to correspond to the ranging signals used in the environment.

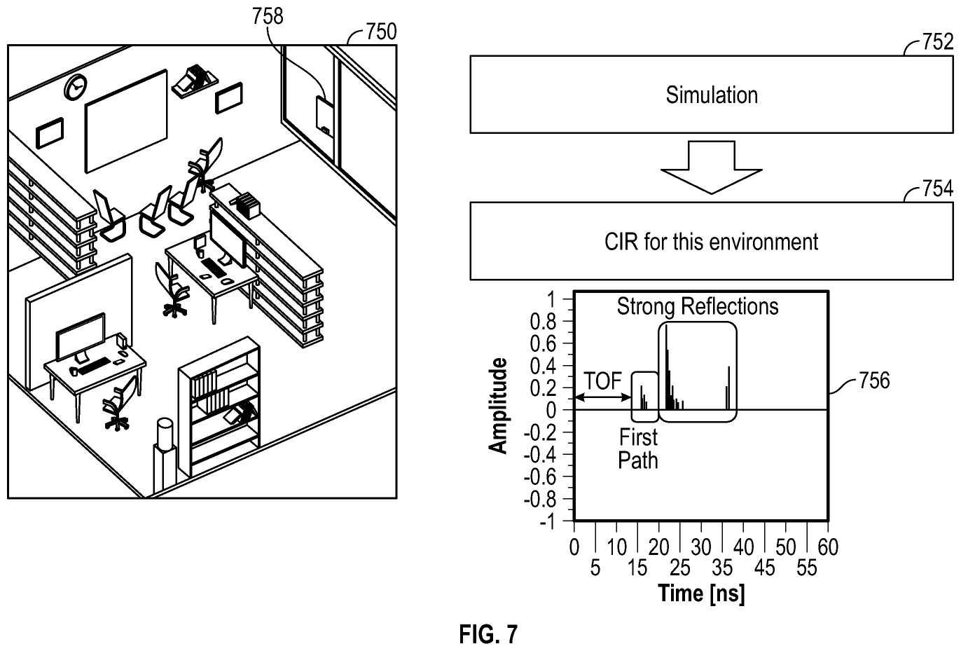

FIG. 7 graphically illustrates a simulation approach in which the UWB test signal transmitted by the UWB transmitter device is determined through electromagnetic field simulation. The model environment 750 is developed using software and shows the position of the UWB receiver device 758 in the model environment. The simulation 752 simulates the UWB ranging signal transmitted in the model environment to determine the CIR for the environment 754. FIG. 7 shows the simulated CIR waveform 756.

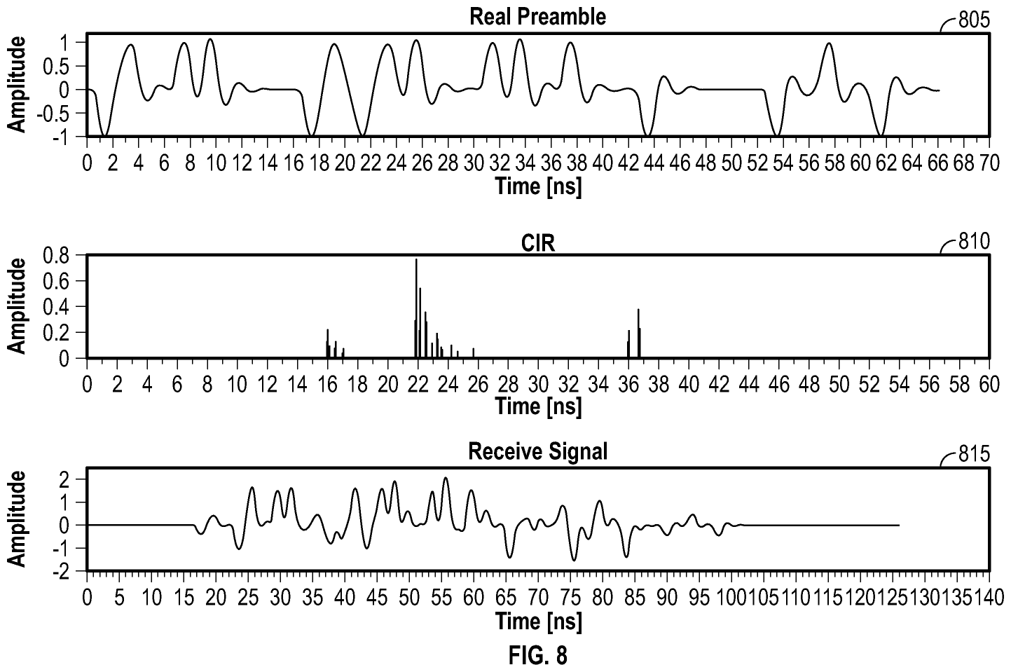

FIG. 8 shows waveforms of the simulation. The top waveform 805 is the UWB transmit signal. It includes a radio packet preamble without the carrier frequency shown. The middle waveform 810 is the CIR determined by the simulation and the bottom waveform 815 is the signal to be transmitted by the UWB transmitter device of the test system that represents the signal that will be seen by the UWB receiver device in the actual environment.

The UWB receiver device under test determines ranging information, such as a ranging distance for the UWB ranging signal, while the UWB receiver device is in the RF shielded container. In some examples, the UWB receiver device performs deconvolution of the UWB signal received in the RF shielded container to estimate a channel impulse response (CIR) of the transmitted UWB signal and calculates TOF information. If the UWB receiver device is a UWB capable PACS Reader device, the Reader device may calculate distance or angle according to normal operation and a result of the test may be made available at a test port of the Reader device. If the UWB receiver device under test is a Smart UWB capable device, such as a smartphone, a testing application or Test App may have to be downloaded to the Smart UWB capable device to implement testing.

Another approach to determine the signal to be transmitted by the UWB transmitter device of the test system is a measurement approach. In this approach, a first stage of testing is done in the actual environment in which the UWB receiver device will be used. A UWB signal such as a UWB ranging signal may be transmit in the environment using a first antenna and a UWB transmitter. A second antenna or multiple antennas are used to measure the electromagnetic response in the environment. The measured MPCs resulting from the transmission can be aggregated into the signal to be transmitted by the UWB transmitter device of the test system.

While this approach is more time consuming than the simulation approach, the measurement approach has the result, as in the simulation approach, that a UWB test signal is generated and can be stored in memory or otherwise recorded. The test can be run using the test system multiple times using the generated UWB test signal. The generated UWB test is portable and can be sent to different testing systems. This is useful for when there are different development areas in different geographical locations. Once the UWB test signal is generated, it can be used by other test units of different development sites for the UWB receiver device.

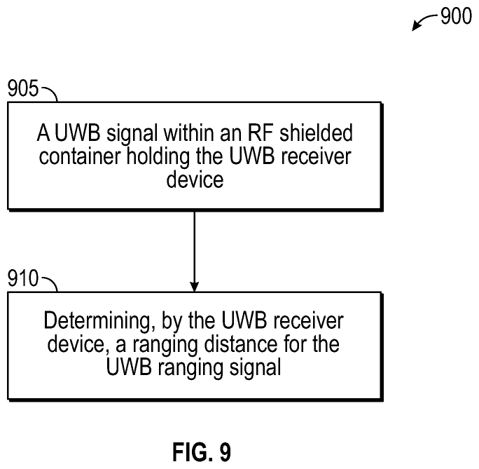

FIG. 9 is a flow diagram of a method 900 of testing a UWB receiver device. The UWB device may be included in a seamless PACS. The UWB receiver device may be a UWB capable device such as a UWB capable Reader device or Reader/Control device. In some examples, the UWB receiver device is a Smart UWB capable device such as a smartphone for use by someone wishing to gain physical access to an access-controlled area.

At 905, a UWB signal is transmitted within an RF shielded container holding the UWB receiver device under test. The transmitted signal is representative of multi-path components (MPCs) of resulting signals in an end-use environment for the UWB receiver device resulting from transmitting a UWB ranging signal in the end-use environment. In some examples, the transmitted signal is representative of the MPCs that result in the end-use environment due to reflections of a UWB ranging signal that would be transmitted by a UWB device separate from the UWB receiver device under test. The signal transmitted in the RF shielded container may be determined through simulation or previous measurement.

At 910, the UWB receiver device in the RF shielded container determines a ranging distance using the signal received in the RF shielded container. This determines if the UWB receiver device would have any difficulty in determining the distance when a UWB ranging signal is transmitted in the end-use environment.

The devices, systems and methods described herein can provide a repeatable technique to test UWB capable devices leading to streamlining of the development of UWB devices even though the development may be in different areas in different geographical locations. Examples have been described that relate to UWB capable physical access control systems, but the devices, systems and methods can be used to streamline development of a UWB device for other UWB system applications.

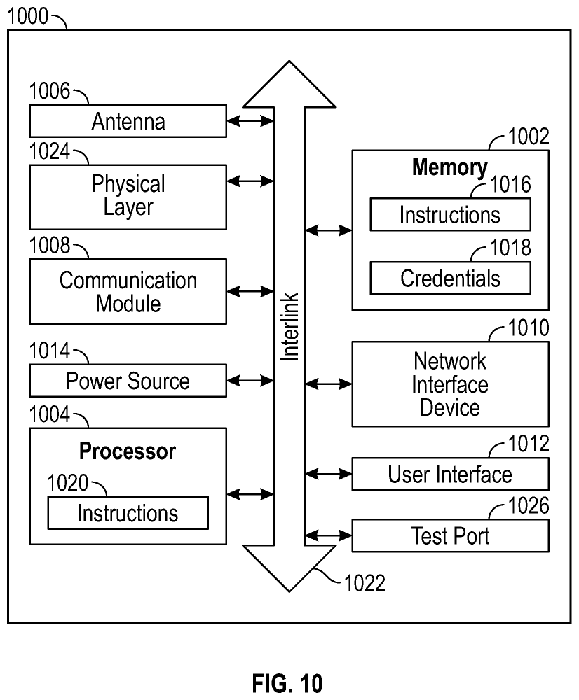

FIG. 10 is a block diagram schematic of various example components of a UWB capable device 1000 (e.g., an embedded device) for supporting the device architectures described and illustrated herein. The device 1000 of FIG. 10 could be, for example, a UWB capable reader device that authenticates credential information of authority, status, rights, and/or entitlement to privileges for the holder of a credential UWB capable device. At a basic level, a reader device can include an interface (e.g., one or more antennas and Integrated Circuit (IC) chip(s)), which permit the reader device to exchange data with another device, such as a credential device or a reader device. One example of credential device is an RFID smartcard that has data stored thereon allowing a holder of the credential device to access a secure area or asset protected by the reader device.

With reference specifically to FIG. 10, additional examples of a UWB capable device 1000 for supporting the device architecture described and illustrated herein may generally include one or more of a memory 1002, a processor 1004, one or more antennas 1006, a communication port or communication module 1008, a network interface device 1010, a user interface 1012, and a power source 1014 or power supply.

Memory 1002 can be used in connection with the execution of application programming or instructions by processing circuitry, and for the temporary or long-term storage of program instructions or instruction sets 1016 and/or authorization data 1018, such as credential data, credential authorization data, or access control data or instructions, as well as any data, data structures, and/or computer-executable instructions needed or desired to support the above-described device architecture. For example, memory 1002 can contain executable instructions 1016 that are used by a processor 1004 of the processing circuitry to run other components of device 1000, to make access determinations based on credential or authorization data 1018, and/or to perform any of the functions or operations described herein, such as the method of FIG. 9 for example. Memory 1002 can comprise a computer readable medium that can be any medium that can contain, store, communicate, or transport data, program code, or instructions for use by or in connection with device 1000. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), Dynamic RAM (DRAM), any solid-state storage device, in general, a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Processor 1004 can correspond to one or more computer processing devices or resources. For instance, processor 1004 can be provided as silicon, as a Field Programmable Gate Array (FPGA), an Application-Specific Integrated Circuit (ASIC), any other type of Integrated Circuit (IC) chip, a collection of IC chips, or the like. As a more specific example, processor 1004 can be provided as a microprocessor, Central Processing Unit (CPU), or plurality of microprocessors or CPUs that are configured to execute instructions sets stored in an internal memory 1020 and/or memory 1002.

Antenna 1006 can correspond to one or multiple antennas and can be configured to provide for wireless communications between device 1000 and another device. Antenna(s) 1006 can be coupled to one or more physical (PHY) layers 1024 to operate using one or more wireless communication protocols and operating frequencies including, but not limited to, the IEEE 802.15.1, Bluetooth, Bluetooth Low Energy (BLE), near field communications (NFC), ZigBee, GSM, CDMA, Wi-Fi, RF, UWB, and the like. In an example, antenna 1006 may include one or more antennas coupled to one or more physical layers 1024 to operate using UWB for in band activity/communication and Bluetooth (e.g., BLE) for out-of-band (OOB) activity/communication. However, any RFID or personal area network (PAN) technologies, such as the IEEE 502.15.1, near field communications (NFC), ZigBee, GSM, CDMA, Wi-Fi, etc., may alternatively or additionally be used for the OOB activity/communication described herein.

Device 1000 may additionally include a communication module 1008 and/or network interface device 1010. Communication module 1008 can be configured to communicate according to any suitable communications protocol with one or more different systems or devices either remote or local to device 1000. Network interface device 1010 includes hardware to facilitate communications with other devices over a communication network utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., IEEE 802.11 family of standards known as Wi-Fi, IEEE 802.16 family of standards known as WiMax), IEEE 802.15.4 family of standards, and peer-to-peer (P2P) networks, among others. In some examples, network interface device 1010 can include an Ethernet port or other physical jack, a Wi-Fi card, a Network Interface Card (NIC), a cellular interface (e.g., antenna, filters, and associated circuitry), or the like. In some examples, network interface device 1010 can include a plurality of antennas to wirelessly communicate using at least one of single-input multiple-output (SIMO), multiple-input multiple-output (MIMO), or multiple-input single-output (MISO) techniques. In some example embodiments, one or more of the antenna 1006, communication module 1008, and/or network interface device 1010 or subcomponents thereof, may be integrated as a single module or device, function or operate as if they were a single module or device, or may comprise of elements that are shared between them.

User interface 1012 can include one or more input devices and/or display devices. Examples of suitable user input devices that can be included in user interface 1012 include, without limitation, one or more buttons, a keyboard, a mouse, a touch-sensitive surface, a stylus, a camera, a microphone, etc. Examples of suitable user output devices that can be included in user interface 1012 include, without limitation, one or more LEDs, an LCD panel, a display screen, a touchscreen, one or more lights, a speaker, etc. It should be appreciated that user interface 1012 can also include a combined user input and user output device, such as a touch-sensitive display or the like.

Power source 1014 can be any suitable internal power source, such as a battery, capacitive power source or similar type of charge-storage device, etc., and/or can include one or more power conversion circuits suitable to convert external power into suitable power (e.g., conversion of externally-supplied AC power into DC power) for components of the device 1000.

Device 1000 can also include one or more interlinks or buses 1022 operable to transmit communications between the various hardware components of the device. A system bus 1022 can be any of several types of commercially available bus structures or bus architectures. The system bus may be able to provide TOF information available to a test port 1026.

### ADDITIONAL DISCLOSURE AND EXAMPLES

Example 1 includes subject matter (such as a test system) comprising a radio frequency (RF) shielded container, the shielded container to house a UWB receiver device under test; an RF antenna arranged within the RF shielded container; and a UWB transmitter device operatively coupled to the RF antenna and configured to transmit a UWB signal within the RF shielded container using the antenna, wherein the transmitted UWB signal is representative of multi-path components (MPCs) of resulting signals in an end-use environment of the UWB receiver device resulting from transmitting a UWB ranging signal in the end-use environment.

In Example 2, the subject matter of Example 1 optionally includes a UWB transmitter device configured to transmit a UWB signal representing transmitting, in the end-use environment, a UWB ranging signal that includes a specified pulse pattern.

In Example 3, the subject matter of one or both of Examples 1 and 2 optionally includes a UWB transmitter device configured to transmit a UWB signal representing transmitting, in the end-use environment, a UWB ranging signal that includes a radio packet having a specified preamble.

In Example 4, the subject matter of one or both of Examples 1 and 3 optionally includes a UWB transmitter device configured to transmit a UWB signal representing transmitting, in the end-use environment, a UWB ranging signal that includes a radio packet that includes a scrambled timestamp sequence.

In Example 5, the subject matter of one or any combination of Examples 1-4 optionally includes a UWB transmitter device configured to transmit a UWB signal generated using electromagnetic field simulation software.

In Example 6, the subject matter of one or any combination of Examples 1-4 optionally includes a UWB transmitter device configured to transmit a UWB signal that is an aggregate of measured MPCs resulting from transmitting the UWB ranging signal in the end-use environment.

In Example 7, the subject matter of one or any combination of Examples 1-6 optionally includes a RF shielded container includes one or more RF attenuators.

In Example 8, the subject matter of one or any combination of Examples 1-7 optionally includes a UWB receiver device operable within the RF shielded container to determine a ranging distance for the UWB ranging signal.

In Example 9, the subject matter of Example 8 optionally includes a UWB receiver device configured to perform deconvolution of a UWB signal received within the RF shielded container to estimate a channel impulse response (CIR) of the transmitted UWB signal and determine time-of-flight information using the estimated CIR.

Example 10 includes subject matter (such as a method of testing a UWB receiver device of a seamless physical access control system) or can optionally be combined with one or any combination of Examples 1-9 to include such subject matter comprising transmitting a UWB signal within an RF shielded container holding the UWB receiver device, wherein the UWB signal transmitted within the container is representative of multi-path components (MPCs) of resulting signals in an end-use environment for the UWB receiver device resulting from transmitting a UWB ranging signal in the end-use environment; and determining, by the UWB receiver device, a ranging distance for the UWB ranging signal.

In Example 11, the subject matter of Example 10 optionally includes the UWB receiver device performing deconvolution of a received UWB signal to estimate a channel impulse response (CIR) of the transmitted UWB signal and determining time-of-flight information using the estimated CIR.

In Example 12, the subject matter of one or both of Examples 10 and 11 optionally includes transmitting a UWB signal that represents transmitting, in the end-use environment, a UWB ranging signal that includes a specified pulse pattern.

In Example 13, the subject matter of one or any combination of Examples 10-12 optionally includes transmitting a UWB signal that represents transmitting, in the end-use environment, a UWB ranging signal that includes a radio packet having a specified preamble.

In Example 14, the subject matter of one or any combination of Examples 10-12 optionally includes transmitting a UWB signal that represents transmitting, in the end-use environment, a UWB ranging signal that includes a radio packet that includes a scrambled timestamp sequence.

In Example 15, the subject matter of one or any combination of Examples 10-14 optionally includes transmitting a UWB signal generated using electromagnetic field simulation software.

In Example 16, the subject matter of one or any combination of Examples 10-14 optionally includes transmitting a UWB ranging signal using a first antenna; measuring MPCs of resulting signals that result from transmitting the UWB ranging signal; and aggregating the MPCs of the resulting signals into the UWB signal transmitted into the RF shielded container.

In Example 17, the subject matter of one or any combination of Examples 10-16 optionally includes the UWB receiver device being a UWB capable reader device.

Example 18 includes subject matter (or can optionally be combined with one or any combination of Examples 1-17 to include such subject matter) such as a computer-readable storage medium including instructions that, when executed by processing circuitry of an ultra-wide band (UWB) device test unit, causes the test unit to perform acts comprising transmitting a UWB signal within an RF shielded container holding the UWB device, wherein the UWB signal transmitted within the container is representative of multi-path components (MPCs) of resulting signals in an end-use environment for the UWB device resulting from transmitting a UWB ranging signal in the end-use environment; and receiving a ranging distance from the UWB device for the UWB ranging signal.

In Example 19, the subject matter of Example 18 optionally includes instructions that cause the test unit to perform acts including transmitting a UWB signal that represents transmitting, in the end-use environment, a UWB ranging signal that includes a specified synchronization pattern.

In Example 20, the subject matter of one or both of Examples 18 and 19 optionally includes instructions that cause the test unit to perform acts including transmitting a UWB signal representing transmitting, in the end-use environment, a UWB ranging signal that includes a radio packet that includes a scrambled timestamp sequence.

The above Examples can be combined in any permutation or combination. The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. In the above Detailed Description, various features may be grouped together to streamline the disclosure. This should not be interpreted as intending that an unclaimed disclosed feature is essential to any claim. Rather, the subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope should be determined with reference to the appended claims, along with the full scope of equivalents to which such claims are entitled.

1. A test system comprising:
a radio frequency (RF) shielded container, the shielded container to house a UWB receiver device under test;
an RF antenna arranged within the RF shielded container; and
a UWB transmitter device operatively coupled to the RF antenna and configured to transmit a UWB signal within the RF shielded container using the antenna, wherein the transmitted UWB signal is representative of multi-path components (MPCs) of resulting signals in an end-use environment of the UWB receiver device resulting from transmitting a UWB ranging signal in the end-use environment.

2. The test system of claim 1, wherein the UWB transmitter device is configured to transmit a UWB signal representing transmitting, in the end-use environment, a UWB ranging signal that includes a specified pulse pattern.

3. The test system of claim 1, wherein the UWB transmitter device is configured to transmit a UWB signal representing transmitting, in the end-use environment, a UWB ranging signal that includes a radio packet having a specified preamble.

4. The test system of claim 1, wherein the UWB transmitter device is configured to transmit a UWB signal representing transmitting, in the end-use environment, a UWB ranging signal that includes a radio packet that includes a scrambled timestamp sequence.

5. The test system of claim 1, wherein the UWB transmitter device is configured to transmit a UWB signal generated using electromagnetic field simulation software.

6. The test system of claim 1, wherein the UWB transmitter device is configured to transmit a UWB signal that is an aggregate of measured MPCs resulting from transmitting the UWB ranging signal in the end-use environment.

7. The test system of claim 1, wherein the RF shielded container includes one or more RF attenuators.

8. The test system of claim 1, including the UWB receiver device, wherein the UWB receiver device is operable within the RF shielded container to determine a ranging distance for the UWB ranging signal.

9. The test system of claim 8, wherein the UWB receiver device is configured to perform deconvolution of a UWB signal received within the RF shielded container to estimate a channel impulse response (CIR) of the transmitted UWB signal and determine time-of-flight information using the estimated CIR.

10. A method of testing an Ultra-Wide Band (UWB) receiver device of a seamless physical access control system, the method comprising:
transmitting a UWB signal within an RF shielded container holding the UWB receiver device, wherein the UWB signal transmitted within the container is representative of multi-path components (MPCs) of resulting signals in an end-use environment for the UWB receiver device resulting from transmitting a UWB ranging signal in the end-use environment; and
determining, by the UWB receiver device, a ranging distance for the UWB ranging signal.

11. The method of claim 10, wherein determining the ranging distance includes the UWB receiver device performing deconvolution of a received UWB signal to estimate a channel impulse response (CIR) of the transmitted UWB signal and determining time-of-flight information using the estimated CIR.

12. The method of claim 10, wherein transmitting the UWB signal includes transmitting a UWB signal that represents transmitting, in the end-use environment, a UWB ranging signal that includes a specified pulse pattern.

13. The method of claim 10, wherein transmitting the UWB signal includes transmitting a UWB signal that represents transmitting, in the end-use environment, a UWB ranging signal that includes a radio packet having a specified preamble.

14. The method of claim 10, wherein transmitting the UWB signal includes transmitting a UWB signal that represents transmitting, in the end-use environment, a UWB ranging signal that includes a radio packet that includes a scrambled timestamp sequence.

15. The method of claim 10, wherein transmitting the UWB signal includes transmitting a UWB signal generated using electromagnetic field simulation software.

16. The method of claim 10, wherein transmitting the UWB signal includes:
transmitting a UWB ranging signal using a first antenna;
measuring MPCs of resulting signals that result from transmitting the UWB ranging signal; and
aggregating the MPCs of the resulting signals into the UWB signal transmitted into the RF shielded container.

17. The method of claim 1, wherein the UWB receiver device is a UWB capable reader device.

18. A computer-readable storage medium including instructions that, when executed by processing circuitry of an ultra-wide band (UWB) device test unit, causes the test unit to perform acts comprising:
transmitting a UWB signal within an RF shielded container holding the UWB device, wherein the UWB signal transmitted within the container is representative of multi-path components (MPCs) of resulting signals in an end-use environment for the UWB device resulting from transmitting a UWB ranging signal in the end-use environment; and
receiving a ranging distance from the UWB device for the UWB ranging signal.

19. The computer-readable storage medium of claim 18, further including instructions that cause the test unit to perform acts including transmitting a UWB signal that represents transmitting, in the end-use environment, a UWB ranging signal that includes a specified synchronization pattern.

20. The computer-readable storage medium of claim 18, further including instructions that cause the test unit to perform acts including transmitting a UWB signal representing transmitting, in the end-use environment, a UWB ranging signal that includes a radio packet that includes a scrambled timestamp sequence.
